(19) United States
(12) Patent Application Publication
(10) Pub. No.: US 2019/0287453 A1
(43) Pub. Date: Sep. 19, 2019

(54) OLED DISPLAY AND OPTICAL COMPENSATION METHOD FOR THE SAME

(71) Applicants: Interface Technology (ChengDu) Co., Ltd., Chengdu (CN); Interface Optoelectronics (ShenZhen) Co., Ltd., Shenzhen (CN); General Interface Solution Limited, Miaoli County (TW)

(72) Inventor: Ruey-Shing Weng, Miaoli County (TW)

(21) Appl. No.: 15/945,107

(22) Filed: Apr. 4, 2018

(30) Foreign Application Priority Data
Mar. 15, 2018 (CN) 201810215125.4

(51) Int. Cl. G09G 3/3208

(52) U.S. Cl. CPC G09G 3/3208; G09G 2320/0626

(57) ABSTRACT

Provided is an OLED display optical compensation method that involves forming photosensitive components on a soft substrate inside a display to detect brightness information of each sub-pixel OLED, and analyzing the brightness information to calculate an optical compensation parameter, so as to adjust emission brightness of each sub-pixel OLED.

### CROSS-REFERENCE TO RELATED PATENT APPLICATION

This non-provisional application claims priority to and the benefit of, pursuant to 35 U.S.C. § 119(a), patent application Serial No. CN201810215125.4 filed in China on Mar. 15, 2018. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to the field of display screens and, more particularly, to an OLED display characterized by a built-in optical compensation structure and thereby capable of detecting and adjusting each sub-pixel emission brightness independently.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The evolution of integrated circuit panel display technology, generation after generation, results in greatly extended service life of emission-related materials for use in manufacturing organic light-emitting diodes (OLEDs), thereby bringing about massive commercialization of OLED displays. Conventional OLED displays come in two types, flatly-fixed rigid and flexible. The flatly-fixed rigid OLED displays usually require glass substrates. The flexible OLED displays usually use soft flexible materials, such as polyimide (PI), as substrates.

Referring to FIG. 1, there is shown a conventional flexible OLED display structure. The flexible OLED display is manufactured by following the steps: disposing a soft substrate 20 (for example, a polyimide substrate) on a hard substrate 10 (for example, a glass substrate); forming thin-film transistors (TFT) 30 and OLEDs 4; and removing the soft substrate 20 from a hard substrate. The soft substrate 20 can be replaced with a bilayer soft substrate (20, 20a) to augment the support for the OLED substrate.

A panel of an active-matrix OLED display (AMOLED display) essentially comprises a thin-film transistor layer composed of a plurality of thin-film transistors and an OLED layer corresponding in position to the thin-film transistors. The OLED layer comprises a plurality of OLEDs arranged in a matrix. Each OLED is known as a sub-pixel. Each sub-pixel is driven by a corresponding one of the thin-film transistors. The OLEDs are current-driven components, whereas the thin-film transistors drive minute differences in characteristics between components; hence, the emission brightness of the panel varies greatly. Since the thin-film transistors differ from the OLEDs in characteristics, the emission brightness of an OLED module is nonuniform, that is, display brightness nonuniformity (mura effect). A sub-pixel circuit inside the OLED panel is mainly intended to compensate for characteristic variations in the operating threshold voltage (Vth) for driving the thin-film transistors. However, the aforesaid compensation technique fails to compensate for variations in characteristics of the

OLEDs and the other parameters of the thin-film transistors. Hence, conventional display manufacturers usually use external compensation methods to effectuate optical compensation, also known as OLED brightness nonuniformity elimination (De-Mura), with a view to enabling the OLEDs to produce uniform brightness.

The technology of external brightness nonuniformity elimination substantially comes in two categories, electrical detection compensation methods and optical detection compensation methods. The external electrical compensation methods usually require an external driving circuit to provide voltage to each OLED display pixel, so as to detect current-voltage (I-V) characteristics of each display pixel and then calculate the compensation coefficient of each sub-pixel, thereby correcting image data. However, the electrical detection compensation methods can only detect the characteristics of the thin-film transistors or the OLEDs beforehand in a purely electrical way, and cannot detect brightness differences finally presented by the OLEDs. Therefore, the electrical detection compensation methods cannot fully compensate for brightness nonuniformity.

The external optical compensation methods entail detecting brightness information of each sub-pixel in the OLED panel directly with an optical instrument, by following the steps: a. recording brightness information of each sub-pixel in the OLED panel with a high-precision optical instrument; b. calculating and generating a compensation parameter of each sub-pixel; c. compressing the compensation parameter and writing the compressed compensation parameter into a Flash memory; and d. reading from the Flash memory and decompressing compensation information by the driving circuit, then correcting image data according to the compensation information and providing the corrected image data to the OLEDs by the driving circuit, so as to effectuate display.

However, the external optical compensation methods must use a high-definition optical instrument in order to detect brightness of each sub-pixel, and thus an optical instrument with high (at least 4×) resolution is required. Owing to the high resolution, operations, such as picture capturing, computation, data transmission, and storage, take much time and take up much space. Furthermore, the external optical compensation methods require a Flash memory for storing optical compensation information and thus incur high production costs.

In addition, the external optical compensation methods are only suitable for flatly-fixed rigid OLED displays or suitable for performing detection when the OLEDs are flat, that is, before the OLEDs are bent and mounted in place. Hence, characteristics of the OLEDs are affected by temperature in a subsequent process or as a result of curved surface adhesion, and in consequence it is impossible to carry out optical compensation.

### SUMMARY

It is an objective of the present invention to overcome a drawback of the prior art, that is, detection of an emission brightness with an external optical instrument being limited by product appearance, survey angle, external interference, and costs, and provide an organic light-emitting diode (OLED) display, to not only perform computation and detection of optical compensation after a display has been incorporated into a complete finished product, but also effectively enhance process yield.

In order to achieve the above and other objectives, the present invention provides an OLED display, comprising: a first soft substrate, a plurality of photosensitive components, a second soft substrate, a plurality of thin-film transistors, a plurality of OLEDs and an optical compensation control module. The photosensitive components are disposed on the first soft substrate. The second soft substrate is disposed on the plurality of photosensitive components. The thin-film transistors are disposed on the second soft substrate. The OLEDs are disposed on the plurality of thin-film transistors and corresponding in position thereto, respectively, to provide an emission brightness. The optical compensation control module is electrically connected to the plurality of photosensitive components and the plurality of OLEDs. Wherein the plurality of photosensitive components detects the emission brightness of the plurality of OLEDs, respectively, converts the detected emission brightness into a brightness information, and transmits the brightness information to the optical compensation control module such that the optical compensation control module calculates an optical compensation parameter according to the brightness information and controls the plurality of OLEDs to adjust brightness according to the optical compensation parameter.

The present invention also provides an OLED display optical compensation method, comprising the steps of: (a) providing the OLED display of claim 1, the OLED comprising the first soft substrate, the plurality of photosensitive components, the second soft substrate, the plurality of thin-film transistors, the plurality of OLEDs, and the optical compensation control module. (b) detecting an emission brightness of the plurality of OLEDs and converting the emission brightness into a brightness information, by the plurality of photo diodes, respectively. (c) transmitting the brightness information to the optical compensation control module. (d) calculating brightness uniformity according to the brightness information to generate an optical compensation parameter. (e) controlling the plurality of OLEDs to adjust the emission brightness according to the optical compensation parameter and an image data source.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a schematic view of the stacking structure of a conventional flexible OLED display in the prior art;

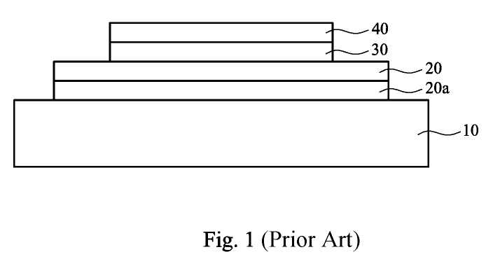

FIG. 2 is a schematic view of the stacking structure of an OLED display according to a preferred embodiment of the present invention;

FIG. 3 is a schematic view of OLEDs and photosensitive components of the OLED display according to the preferred embodiment of the present invention;

FIG. 4 is a schematic view of the structure of the OLED display according to the preferred embodiment of the present invention;

FIG. 5 is a schematic view of the process flow of analysis of emission brightness of the OLED display according to the preferred embodiment of the present invention; and

FIG. 6 is a schematic view of the process flow of an OLED display optical compensation method according to the present invention.

### DETAILED DESCRIPTION

Features and functions of the technical means and structures applied to the present invention to achieve the aforesaid objectives and effects are depicted by drawings, illustrated with preferred embodiments, and described below so as to be fully comprehensible but not restrictive of the present invention.

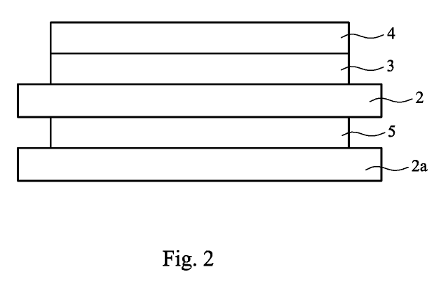

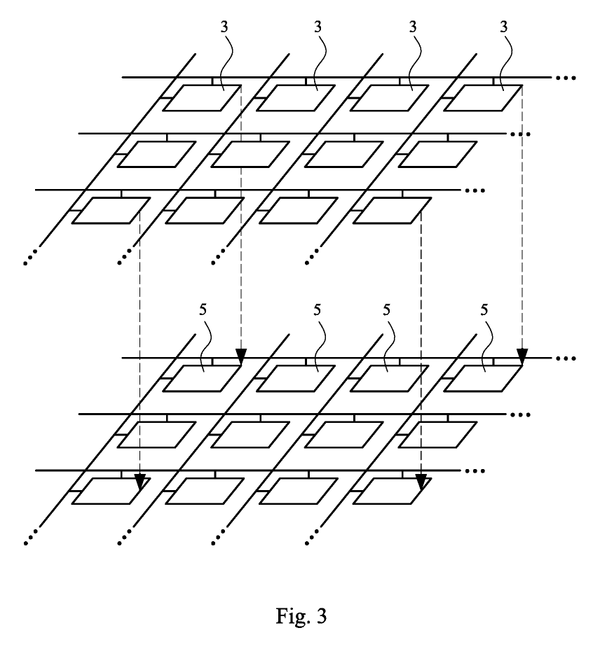

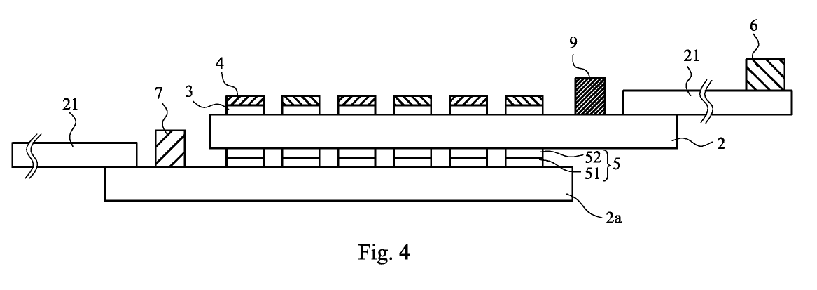

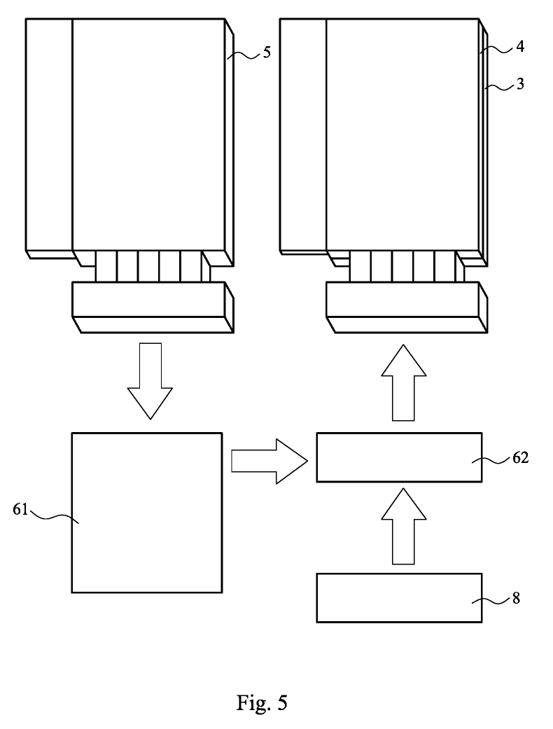

Referring to FIG. 2, FIG. 3, FIG. 4 and FIG. 5, there are shown a schematic view of the stacking structure of an organic light-emitting diode (OLED) display according to a preferred embodiment of the present invention, a schematic view of OLEDs and photosensitive components of the OLED display according to the preferred embodiment of the present invention, a schematic view of the structure of the OLED display according to the preferred embodiment of the present invention, and a schematic view of the process flow of analysis of emission brightness of the OLED display according to the preferred embodiment of the present invention, respectively. The OLED display of the present invention comprises a first soft substrate 2a, a plurality of photosensitive components 5, a second soft substrate 2, a plurality of thin-film transistors 3, a plurality of OLEDs 4, and an optical compensation control module 6.

The first soft substrate 2a and the second soft substrate 2 are preferably polyimide (PI) soft substrate which has excellent flexible characteristics and thus is suitable for use as a substrate for underpinning a flexible display.

The plurality of photosensitive components 5 is disposed on a surface of the first soft substrate 2a and electrically connected to the optical compensation control module 6 through a conducting line to detect an emission brightness of the plurality of OLEDs 4 and transmit the detected emission brightness to the optical compensation control module 6. In the preferred embodiment of the present invention, the photosensitive components 5 are each a photo diode integrally formed on the first soft substrate 2a by an etching process typical of diodes. Owing to its photoelectrical characteristics, the photo diode can detect the emission brightness of each sub-pixel OLED 4 and provide the emission brightness to the optical compensation control module 6. Preferably, an analog to digital converter 7 is disposed on the first soft substrate 2a. The analog to digital converter 7 is disposed at a peripheral frame region of the first soft substrate 2a and connected to the first soft substrate 2a by Chip on Film (COF) to convert the emission brightness into a digital signal whereby computation is performed by the optical compensation control module 6.

The second soft substrate 2 is disposed on the photosensitive components 5. A plurality of thin-film transistors 3 and an OLED driver IC 9 are disposed on a surface of the second soft substrate 2.

The plurality of thin-film transistors 3 is formed integrally on the second soft substrate 2 by an etching process and electrically connected to the OLED driver IC 9 to supply a steady current for driving the emission of the plurality of OLEDs 4. Preferably, the plurality of thin-film transistors 3 corresponds in position to the plurality of photosensitive components 5, respectively. The OLED driver IC 9 is disposed at a peripheral frame region of the second soft substrate 2 and connected to the second soft substrate 2 by Chip on Film (COF).

The plurality of OLEDs 4 is formed integrally on the plurality of thin-film transistors 3 and corresponds in position to the plurality of thin-film transistors 3, respectively, to enable the plurality of thin-film transistors 3 to drive and provide the emission brightness. Given the aforesaid structure, each OLED is aligned with a corresponding one of the thin-film transistors and a corresponding one of the photosensitive components, on the same vertical line; hence, the photosensitive components 5 capture and detect the emission brightness of the sub-pixel OLEDs 4 in a stable manner and transmit the emission brightness to the optical compensation control module 6. It is worth noting that the photosensitive components 5 only need a simple Serial Peripheral Interface (SPI) to feed back the emission brightness information to a system end or the optical compensation control module 6.

The optical compensation control module 6 is electrically connected to the photosensitive components 5 and the plurality of thin-film transistors 3 through a circuit connection board 21. The optical compensation control module 6 comprises a detection calculation unit 61 and an image processing unit 62. The detection calculation unit 61 calculates an optical compensation parameter according to the brightness information of each sub-pixel to allow each sub-pixel to have a unique optical compensation parameter and transmit the optical compensation parameter to the image processing unit 62. The image processing unit 62 effectuates output integration according to the optical compensation parameter and an image data source 8 in order to control the plurality of OLEDs 4 to transmit corrected image data and thereby adjust the emission brightness. The image data source 8 is an original image output signal.

In the embodiment of the present invention, the detection calculation unit 61 is further capable of compensation data storage and thus provides proper optical compensation parameters to meet various compensation needs.

In the embodiment of the present invention, the detection calculation unit 61 is connected to an external system end of the OLED display in part, such as a display, a cellular phone, a tablet, or the motherboard of a computer, such that the system end performs optical compensation, thereby reducing the required circuit space of integrated circuits (IC) or hardware.

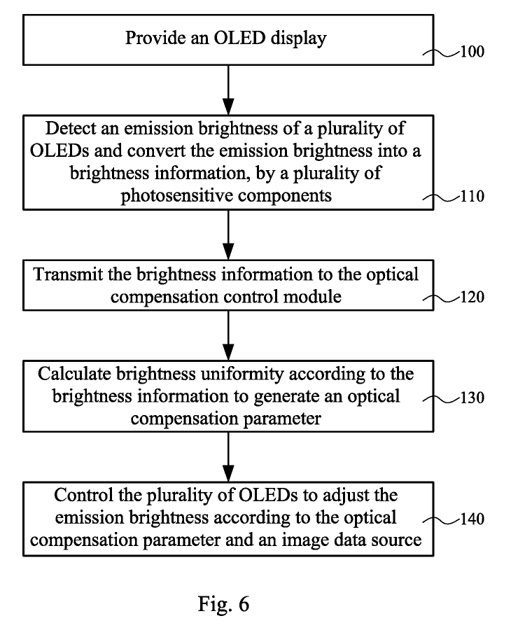

Referring to FIG. 6, there is shown a schematic view of the process flow of an OLED display optical compensation method according to the present invention. The present invention further provides an OLED display optical compensation method which comprises the steps as follows:

Step 100: providing an OLED display. The OLED display comprises the first soft substrate 2a, the plurality of photosensitive components 5, the second soft substrate 2, the plurality of thin-film transistors 3, the plurality of OLEDs 4, and the optical compensation control module 6.

Step 110: detecting an emission brightness of the plurality of OLEDs 4, respectively, and converting the emission brightness into a brightness information by a plurality of photosensitive components 5. The photosensitive components 5 detect the emission brightness of the single-pixel OLEDs 4, respectively, and convert the emission brightness into the brightness information in a digital signal mode by the analog to digital converter 7.

Step 120: transmitting the brightness information to the optical compensation control module 6.

Step 130: calculating brightness uniformity according to the brightness information to generate an optical compensation parameter. The detection calculation unit 61 calculates the optical compensation parameter according to the brightness information of each sub-pixel and transmits the optical compensation parameter to the image processing unit 62.

Step 140: controlling the plurality of OLEDs 4 to adjust the emission brightness according to the optical compensation parameter and an image data source 8. The image processing unit 62 effectuates output integration according to the optical compensation parameter and the image data source 8 and then transmits corrected image data to the OLED driver IC 9, so as for the corrected image data to be driven by an OLED column driver to allow the thin-film transistors 3 to control the plurality of OLEDs 4 to output the corrected image data and adjust the emission brightness.

Therefore, as shown in the accompanying drawings, compared with the prior art, an OLED display and an optical compensation method for the same according to the present invention have advantages as follows:

(1) According to the present invention, a display has therein a photosensitive layer for detecting brightness of each sub-pixel accurately and overcoming a drawback of the prior art, that is, detection of brightness with a conventional external optical instrument is subjected to external optical influence greatly.

(2) The photosensitive layer disposed inside the display detects the brightness of each sub-pixel in a stable manner. Considerations must be given to optical noise as well as the rotational angle and inclination angle between an object under test and the external optical instrument for detecting brightness, thereby affecting detection accuracy.

(3) The present invention eliminates the limitation otherwise imposed by product appearance on the external optical instrument's detection of brightness so that the external optical instrument detects the brightness of a curved-surface screen in a stable manner. After the display has been incorporated into a complete finished product, detection and computation of optical compensation is advantageous in that it compensates for brightness variation arising from the display's time-dependent attenuation.

(4) The present invention enhances the process yield of a flexible OLED display greatly. The total process yield of a conventional flexible OLED display is less than 70%, because a soft substrate not only gives rise to poorer characteristics and brightness uniformity of OLEDs than a hard substrate but also affects characteristics of thin-film transistors and OLEDs in the course of production and adhesion. According to the present invention, brightness nonuniformity caused by a production process is compensated for, and the emission brightness of OLEDs can be persistently monitored and adjusted after a display has been incorporated into a complete finished product, thereby enhancing the total process yield.

The above detailed description sufficiently shows that the present invention has non-obviousness and novelty and thus meets patentability requirements. However, the aforesaid preferred embodiments are illustrative of the present invention only, but should not be interpreted as restrictive of the scope of the present invention. Hence, all equivalent changes and modifications made to the aforesaid embodiments should fall within the scope of the claims of the present invention.

What is claimed is:

1. An OLED (Organic Light-Emitting Diode) display, comprising:
a first soft substrate;
a plurality of photosensitive components disposed on the first soft substrate;
a second soft substrate disposed on the plurality of photosensitive components;
a plurality of thin-film transistors disposed on the second soft substrate;
a plurality of OLEDs disposed on the plurality of thin-film transistors and corresponding in position thereto, respectively, to provide an emission brightness; and
an optical compensation control module electrically connected to the plurality of photosensitive components and the plurality of OLEDs,
wherein the plurality of photosensitive components detects the emission brightness of the plurality of OLEDs, respectively, converts the detected emission brightness into a brightness information, and transmits the brightness information to the optical compensation control module such that the optical compensation control module calculates an optical compensation parameter according to the brightness information and controls the plurality of OLEDs to adjust brightness according to the optical compensation parameter.

2. The OLED display according to claim 1, wherein the optical compensation control module further comprises a detection calculation unit for calculating the optical compensation parameter according to the brightness information and comprises an image processing unit for controlling the plurality of OLEDs to adjust the emission brightness according to the optical compensation parameter and an image data source.

3. The OLED display according to claim 2, wherein the detection calculation unit is capable of compensation data storage and provides proper said optical compensation parameter to meet various compensation needs.

4. The OLED display according to claim 1, wherein the plurality of photosensitive components is of the same number as the plurality of OLEDs.

5. The OLED display according to claim 1, wherein the second soft substrate has thereon an OLED driver IC electrically connected to the plurality of thin-film transistors.

6. The OLED display according to claim 1, wherein the photosensitive components are each a photo diode.

7. The OLED display according to claim 1, wherein the first soft substrate has thereon an analog to digital converter connected to the first soft substrate by Chip on Film (COF).

8. An OLED display optical compensation method, comprising the steps of:
a. providing the OLED display of claim 1, the OLED comprising the first soft substrate, the plurality of photosensitive components, the second soft substrate, the plurality of thin-film transistors, the plurality of OLEDs, and the optical compensation control module;
b. detecting an emission brightness of the plurality of OLEDs and converting the emission brightness into a brightness information, by the plurality of photo diodes, respectively;
c. transmitting the brightness information to the optical compensation control module;
d. calculating brightness uniformity according to the brightness information to generate an optical compensation parameter; and
e. controlling the plurality of OLEDs to adjust the emission brightness according to the optical compensation parameter and an image data source.

9. The OLED display optical compensation method according to claim 8, wherein the step b further comprises converting the emission brightness into the brightness information in a digital signal mode by an analog to digital converter.

10. The OLED display optical compensation method according to claim 8, wherein the step d further comprises effectuating output integration according to the optical compensation parameter and the image data source and then transmitting corrected image data to an OLED driver IC, by the image processing unit, so as for the plurality of thin-film transistors to control the plurality of OLEDs to output the corrected image data.
